(19) United States
(12) Patent Application Publication
(10) Pub. No.: US 2025/0052885 A1
(43) Pub. Date: Feb. 13, 2025

(54) ULTRA-HIGH RESOLUTION DISPLACEMENT-SENSING DOPPLER RADAR

(71) Applicant: The Regents of the University of California, Oakland, CA (US)

(72) Inventors: Hao Wang, Davis, CA (US); Omeed Momeni, Davis, CA (US); Hamidreza Afzal, Davis, CA (US)

(73) Assignee: The Regents of the University of California, Oakland, CA (US)

(21) Appl. No.: 18/722,811

(22) PCT Filed: Feb. 7, 2023
(86) PCT No.: PCT/US2023/062155

§ 371 Date: Jun. 21, 2024

Related U.S. Application Data
(60) Provisional application No. 63/307,255, filed on Feb. 7, 2022.

(51) Int. Cl. G01S 13/58; G01S 7/35

(52) U.S. Cl. CPC G01S 13/583; G01S 7/354

(57) ABSTRACT

A displacement-sensing Doppler radar with ultra-low noise and high sensing resolution is provided. The radar includes N two frequency synthesizers to respectively generate, at different frequencies, a transmitted signal that is radiated toward a target object, and a local oscillator (LO) signal. The radar further includes a mixer and a rectifier to: (1) receive a returned signal from the target object carrying phase delays corresponding to detected displacements of the target object; (2) mix the returned signal and the LO signal to generate a down-converted sine-wave intermediate frequency (IF) signal; and (3) rectify the sine-wave IF signal to a square-wave IF signal, which also carries the displacement-induced phase delays. The radar also includes a phase demodulation module to convert the displacement-induced phase delays into a pulse-modulated signal. The radar further includes a low-pass filter to convert the modulated pulse signal into an output voltage signal indicative of the detected displacements.

### CROSS-REFERENCE TO RELATED APPLICATION

This application claims the benefit of U.S. Provisional Patent Application Ser. No. 63/307,255, entitled “ULTRA-HIGH RANGE RESOLUTION DOPPLER RADAR,” filed on 7 Feb. 2022, the contents of which are incorporated by reference herein.

### BACKGROUND

The disclosed embodiments generally relate to the design of Doppler radars. More specifically, the disclosed embodiments relate to the design of low-noise, low-power Doppler radars for high-resolution displacement and vibration sensing applications.

### RELATED ART

Continuous-Wave (CW) radars, also called Doppler radars, radiate single-tone signals on objects, and receive reflected signals with phase/frequency changes of ϕ_{obj} due to the Doppler effect. Thus, an object's relative displacement and speed can be detected. However, Doppler radars suffer from an inherent problem of “detection nulls” wherein the radar's detection gain periodically reaches null (or zero) when the object's distance from the radar is an integer multiple of λ_{c}/4, wherein λ_{c} is the wavelength of the radiated/detection signal (Tx).

In order to eliminate detection nulls, existing CW or Doppler radars apply quadrature demodulation on a signal (Rx) received from a detection target. By doing so, a non-zero-gain path can always be found between the in-phase path and the quadrature-phase path of the receiver chain. However, the detection gain in such a detection scheme is still a non-linear function of ϕ_{obj}, and heavy digital signal processing (DSP) is needed to attain the accurate value of ϕ_{obj}.

To alleviate unwanted effects such as flicker noise and DC offset, existing Doppler radars typically adopt a heterodyne structure in which an intermediate frequency (IF) signal is mixed with a local oscillator frequency (LO) signal to generate a double-side-band (DSB) transmitted signal Tx. As a result, quadrature demodulation is also required in this radar structure to extract the phase information from the received DSB signal.

However, to achieve high sensing resolution for the radar, quadrature demodulation structure requires both exceptionally good matching in hardware implementation and robust DSP compensation. Moreover, the received signal amplitude/power must be detected/calibrated in order to accurately calculate the received phase information ϕ_{obj}. Unfortunately, the quadrature demodulation structure and the associated design concerns significantly increase both system complexity and power consumption, and the problems are further aggravated by using multiple analog-to-digital converters (ADCs) operating at IF.

Although frequency-modulated continuous-wave (FMCW) radars have become popular and widely used, they suffer a drawback when used to sense micrometer-level displacements. Specifically, to enable such high sensing resolution, the carrier frequency and the modulation bandwidth would have to be hundreds of terahertz (10¹⁴ Hz), which is impractical to implement. While phase demodulation techniques can improve the sensing resolution, the requirements in terms of DSP, memory, and computing power remain very high, which lead to very high power consumption of such a device or system.

Hence, what is needed is a Doppler radar design for object displacement sensing with high sensing resolution without the above-mentioned drawbacks of the existing systems and techniques.

### SUMMARY

The disclosed embodiments provide various displacement-sensing Doppler radar designs that simultaneously achieve ultra-low power consumption, ultra-low phase noise, free of detection nulls, and ultra-high displacement-sensing resolutions without using quadrature demodulation. In some embodiments, the above properties of the disclosed displacement-sensing Doppler radars are achieved by a combination of the following design aspects of the disclosed Doppler radars.

First, use of low-noise sub-sampling phase-locked loops (SSPLLs) with the same reference (REF) signal to generate single-tone transmitted/radiated signal and local oscillator (LO) signal without sidebands. As a result, no quadrature demodulation is needed. Second, use of a rectifier to convert a down-converted IF sine-wave signal to a square-wave signal with sharp rising/falling edges. As a result, the displacement-induced phase information is converted into time domain regardless of the power/amplitude of the received signal from the target object. Third, a phase demodulator (PDM) is designed to extract the displacement-induced phase information from the down-converted and rectified IF square-wave signal by comparing the timings of the rising/falling edges of the REF signal (i.e., the demodulation signal) with the timings of the rising/falling edges of the IF square-wave signal. As a result, a pulse-wave signal is generated with pulse width and duty cycle of the pulse-wave signal proportional to input phase differences of the two signals detected by the PDM, and the phase information is converted to pulse duty cycle.

Fourth, a RC low-pass filter (LPF) is coupled to the PDM output and converts the pulse-wave signal into a voltage signal (Vₒᵤₜ) such that, if the target object is undergoing a static displacement, the DC level of Vₒᵤₜ, will change proportionally with the displacement. If the target object is undergoing vibration, Vₒᵤₜ will include a baseband signal having a frequency identical to the vibration frequency and a voltage amplitude proportional to the target object's vibration displacement amplitude. Fifth, the two SSPLLs use a common reference signal to generate the transmitted/radiated signal and the LO signal, wherein the common reference signal also drives the PDM. This signal coherence, combined with the low added noise ensured by the intrinsic features of SSPLL, significantly improves noise performance of the disclosed displacement-sensing radars and enables the disclosed radars to achieve the above-described optimal features.

In one aspect, a displacement-sensing Doppler radar with ultra-low noise and high sensing resolution is disclosed. The Doppler radar includes a first frequency synthesizer to generate a transmitted signal of a first frequency, which is radiated toward a target object, and a second frequency synthesizer to generate a local oscillator (ID) signal of a second frequency different from the first frequency. The Doppler radar further includes a mixer to: (1) receive a returned signal from the target object carrying displacement-induced phase delays corresponding to detected displacements of the target object; and (2) mix the returned signal and the LO signal to generate a down-converted intermediate frequency (IF) signal, wherein the down-converted IF signal carries the displacement-induced phase delays. The Doppler radar additionally includes a phase demodulation module to convert the displacement-induced phase delays into a modulated pulse signal. The Doppler radar further includes a low-pass filter to convert the modulated pulse signal into an output signal having a voltage value indicative of the detected displacements.

In some embodiments, the first frequency synthesizer and the second frequency synthesizer use a common reference (REF) signal of a reference frequency (ƒ_{REF}) to generate the transmitted signal and the LO signal so that the transmitted signal and the LO signal have correlated phase noises according to the phase noise of the common REF signal.

In some embodiments, the transmitted signal has the first frequency ƒ₁=N₁×ƒ_{REF}, the returned signal has the same frequency as the transmitted signal. Moreover, the LO signal has the second frequency ƒ₂=N₂×ƒ_{REF}, and the IF signal has an intermediate frequency ƒ_{IF} such that ƒ_{IF}=|ƒ₁−ƒ₂|=|N₁−N₂|×ƒ_{REF}=N×ƒ_{REF}, wherein N is an integer number.

In some embodiments, N=1 such that the down-converted IF signal has the same frequency as the common REF signal.

In some embodiments, the displacement-sensing Doppler radar further includes a rectifier positioned between the mixer and the phase demodulation module to rectify the down-converted IF signal from a sine-wave signal into a square-wave IF signal, wherein rising/falling edges of the square-wave IF signal are synchronized with the rising/falling zero-crossings of the sine-wave signal.

In some embodiments, the rectifier has a constant phase-to-phase conversion gain when converting the rising/falling zero-crossings of the sine-wave signal into the rising/falling edges of the square-wave IF signal.

In some embodiments, the displacement-induced phase delays are embedded in the temporal locations of the rising/falling edges of the square-wave IF signal.

In some embodiments, the phase demodulation module is configured to convert the displacement-induced phase delays into the modulated pulse signal by first receiving both the square-wave IF signal and the common REF signal using a pair of flip flops. Next, the phase demodulation module compares the rising/falling edges of the square-wave IF signal with the corresponding rising/falling edges of the common REF signal to detect phase differences between the rising/falling edges of the square-wave IF signal and the rising/falling edges of the common REF signal, wherein the detected phase differences are proportional to the displacement-induced phase delays. The phase demodulation module subsequently generates the modulated pulse signal based on the detected phase differences, wherein the duty cycle of the modulated pulse signal is time-varying with a value which is linearly proportional to the detected phase differences.

In some embodiments, the square-wave IF signal and the common REF signal have the same frequency.

In some embodiments, the phase demodulation module is an edge-driven phase demodulator that further comprises a first flip-flop to receive the square-wave IF signal and a second flip-flop to receive the common REF signal. Moreover, the first flip-flop and the second flip-flop are coupled into a state machine which is configuration such that: (1) when a rising/falling edge of the common REF signal is detected, the signal level of the modulated pulse signal is immediately transitioned to ZERO (0); and (2) when a rising/falling edge of the square-wave IF signal is detected, the signal level of the modulated pulse signal is immediately transitioned to ONE (1).

In some embodiments, the phase demodulation module has a constant phase-to-pulse width conversion gain for different detected phase differences.

In some embodiments, the low pass filter is configured to convert the modulated pulse signal into the output voltage signal having an amplitude linearly proportional to the duty cycle of the modulated pulse signal, which itself is linearly proportional to the detected phase differences, wherein the output voltage signal includes a baseband signal associated with displacements of the target object.

In some embodiments, the low pass filter has a constant duty-cycle-to-voltage conversion gain for different generated duty cycles in the modulated pulse signal.

In some embodiments, the low pass filter is configured to filter out phase noises in the modulated pulse signal at frequencies significantly higher than the frequencies of the baseband signal.

In some embodiments, the frequencies of the baseband signal include a vibration frequency associated with a vibration displacement of the target object.

In some embodiments, both the first frequency synthesizer and the second frequency synthesizer are low phase noise synthesizers.

In some embodiments, the first frequency synthesizer is a first low-noise frequency synthesizer selected from the following: (1) a first sub-sampling phase-locked loop (SSPLL); and (2) a first frequency multiplier; and the second frequency synthesizer is a second low-noise frequency synthesizer selected from the following: (1) a second SSPLL; and (2) a second frequency multiplier.

In some embodiments, the Doppler radar is configured to avoid detection nulls by: (1) using the rectifier to perform a constant-gain phase-to-phase conversion from the sine-wave IF signal into the square-wave IF signal; (2) using the phase demodulation module to perform a constant-gain phase-to-pulse width/duty cycle conversion from the square-wave IF signal into the modulated pulse signal; and (3) using the low pass filter to perform a constant-gain duty-cycle-to-voltage-level conversion from the modulated pulse signal to the output voltage signal.

In some embodiments, both the transmitted signal and the returned signal are single-tone signals without sidebands, which allows the displacement-induced phase delays to be extracted from the returned signal using a single mixer without using a quadrature demodulation configured of two mixers or a quadrature demodulation on the square-wave IF signal in digital signal processing to extract the displacement-induced phase delays.

In some embodiments, the displacement-sensing Doppler radar further includes a receiver antenna configured to receive the returned signal and a low noise amplifier (LNA) configured to receive the returned signal and amplify the returned signal to provide additional signal gain.

In some embodiments, the displacement-sensing Doppler radar further includes an analog-to-digital converter (ADC) disposed after the LNA and configured to convert the output voltage signal into a digital signal for further processing.

In some embodiments, the displacement-sensing Doppler radar further includes no more than one ADC to convert the output voltage signal.

In some embodiments, when the target object is undergoing a static displacement, the output voltage signal is a direct current (DC) signal having a level indicative of the static displacement. Alternatively, when the target object is undergoing a vibrational displacement, the output voltage signal is a baseband signal having a frequency identical to the vibration frequency and having a voltage amplitude proportional to an amplitude of the vibrational displacement.

In some embodiments, the output signal can be used to distinguish the displacement directions of the target object based on the direction of change of the voltage value.

In another aspect, a process for detecting object displacements using a Doppler radar is disclosed. During operation, the process generates a transmitted signal of a first frequency, which is radiated toward a target object to cause the transmitted signal to be reflected off the target object. The process the receives a returned signal reflected off the target object carrying displacement-induced phase delays corresponding to a type of detected displacement of the target object. Next, the received signal is mixed with a local oscillator (10) signal to generate a down-converted intermediate frequency (IF) signal, wherein the down-converted IF signal carries the displacement-induced phase delays. The process next processes the down-converted IF signal so that the displacement-induced phase delays is converted into a modulated pulse signal. The process subsequently converts the modulated pulse signal into an output signal having a voltage value indicative of the detected displacement.

In some embodiments, prior to mixing the received signal with the LO signal, the process further generates the LO signal at a second frequency different from the first frequency, wherein both the first frequency and the second frequency are generated based on a common reference signal at a third frequency of ƒ_{REF}.

In some embodiments, the difference between the first frequency and the second frequency is ƒ_{REF}.

In some embodiments, the type of detected displacement of the target object includes either a static displacement or a vibrational displacement.

In some embodiments, the down-converted IF signal is a sine-wave IF signal, and the process converts the displacement-induced phase delays into the modulated pulse signal further by rectifying the sine-wave IF signal into a square-wave IF signal so that the rising/falling edges of the square-wave IF signal are synchronized with the rising/falling zero-crossings of the sine-wave IF signal. As a result, the displacement-induced phase delays are embedded in the rising/falling edges of the square-wave IF signal.

In some embodiments, the square-wave IF signal has the same frequency as the third frequency of ƒ_{REF}, and the process converts the displacement-induced phase delays into the modulated pulse signal by: (1) comparing the rising edges or the falling edges of the square-wave IF signal with the corresponding rising edges or falling edges of the common reference signal; and (2) generating the modulated pulse signal having a duty cycle proportional to the displacement-induced phase delays.

In some embodiments, the output voltage signal has an amplitude linearly proportional to the duty cycle of the modulated pulse signal.

In some embodiments, prior to mixing the received signal, the process further amplifies the received signal to provide additional signal gain.

In some embodiments, after converting the modulated pulse signal into the output voltage signal, the process converts the output voltage signal into a digital signal for further processing.

In some embodiments, the type of detected displacement is a static displacement, and the output voltage signal is a direct current (DC) signal having a level indicative of the static displacement.

In some embodiments, the type of detected displacement is a vibration displacement that includes a vibration frequency, and the output voltage signal is a baseband signal having a frequency identical to the vibration frequency and having a voltage amplitude proportional to an amplitude of the vibrational displacement.

In some embodiments, the detected vibrational displacement has a detection accuracy significantly less than 100 nm.

In some embodiments, the transmitted signal is a single-tone signal without sidebands. As a result, the received signal and the LO signal can be mixed to generate the down-converted IF signal with a single mixer without using either a quadrature demodulation configured with two mixers or a quadrature demodulation configured with a digital signal processor (DSP) to extract the displacement-induced phase delays.

In yet another aspect, a displacement-sensing apparatus is disclosed. This displacement-sensing apparatus includes both a transmitting antenna and a receiver antenna. The displacement-sensing apparatus further includes a continuous wave (CW) Doppler radar coupled to the transmitting antenna and the receiver antenna. This CW Doppler radar further includes: (1) a first frequency synthesizer configured to generate a transmitted signal of a first frequency, which is radiated by the transmitting antenna toward a target object; (2) a low noise amplifier (LNA) configured to amplify a received signal outputted by the receiver antenna, wherein the received signal is generated based on a returned signal reflected off the target object, and wherein the returned signal carrying displacement-induced phase delays corresponding to detected displacements of the target object; (3) a mixer configured to mix the received signal and a local oscillator (LO) signal to generate a down-converted sine-wave intermediate frequency (IF) signal, wherein the down-converted sine-wave IF signal carries the displacement-induced phase delays; (4) a rectifier configured to convert the sine-wave IF signal into a square-wave IF signal, wherein the displacement-induced phase delays are embedded in the rising/falling edges of the square-wave IF signal; and (5) a phase demodulation module configured to convert the displacement-induced phase delays into a modulated pulse signal; and (5) a low-pass filter (LPF) configured to convert the modulated pulse signal into an output signal having a voltage value indicative of the detected displacements.

In some embodiments, the displacement-sensing apparatus further includes a second frequency synthesizer configured to generate the LO signal of a second frequency different from the first frequency, wherein both the first frequency and the second frequency are generated based on a common reference signal at a third frequency of ƒ_{REF}.

In some embodiments, the target object has a distance d_{obj} to both the transmitting antenna and the receiver antenna, and the displacement-induced phase delays includes a phase delay ϕ_{obj}=4π·d_{obj}/λ_{c}, wherein λ_{c} is the wavelength of the transmitted signal.

### BRIEF DESCRIPTION OF THE FIGURES

FIG. 1A shows an existing displacement-sensing frequency-modulated continuous-wave (FMCW) radar using a phase demodulation technique for detecting both the absolute object distance (d_{obj}) and the object speed.

FIG. 1B shows an existing displacement-sensing CW radar based on a simpler low-IF topology for detecting object speed and relative displacement.

FIG. 2 shows a block diagram/topology of a disclosed low-noise CW Doppler radar for object displacement and vibration sensing that eliminates detection nulls without using quadrature demodulation, in accordance with the disclosed embodiments.

FIG. 3A shows a circuit diagram of an edge-driven phase demodulator (EDPD) as an implementation of the PDM in FIG. 2 for extracting the object-induced phase and frequency changes from the edges of the IF_{sqr} signal, in accordance with the disclosed embodiments.

FIG. 3B shows the state machine operating principle of the EDPD for comparing the rising/falling edges of the IF_{sqr} signal and the reference signal (REF), in accordance with the disclosed embodiments

FIG. 3C shows the constant-gain operation principle of the EDPD when converting the detected phase differences between the IF_{sqr} signal 224 and the reference signal (REF) into the duty cycles of Vₚᵤₗ(t) and the DC levels of Vₒᵤₜ(t), in accordance with the disclosed embodiments.

FIG. 4 illustrates exemplary timing diagrams of different signals involved in the operations of the PDM/EDPD associated with different detection cases of the target object, in accordance with the disclosed embodiments.

FIG. 5 illustrates a circuit diagram/radar of a detailed implementation of the proposed Doppler radar in accordance with the disclosed embodiments.

FIG. 6 shows the circuit diagram of the charge pump of the low-PN sub-sampling phase-locked loop (SSPLL) used in the implemented radar of FIG. 5, in accordance with the disclosed embodiments.

FIG. 7 shows the circuit diagrams of a low noise amplifier (LNA) and a passive mixer as detailed implementations of the LNA and the passive mixer used in the implemented radar of FIG. 5, in accordance with the disclosed embodiments.

FIG. 8 shows the circuit diagram of an IF rectifier as a detailed implementation of the rectifier used in the implemented radar of FIG. 5, in accordance with the disclosed embodiments.

FIG. 9 presents a flowchart illustrating a process performed by a disclosed displacement-sensing radar for detecting both static displacements and vibrational displacements of a target object, in accordance with the disclosed embodiments

FIG. 10 shows a photograph of a fabricated chip die of the disclosed displacement-sensing radar in 65 nm CMOS with a core area of 0.92 mm², in accordance with the disclosed embodiments.

FIG. 11A shows the experiment setup for performing static displacement sensing of a target object using the disclosed and fabricated displacement-sensing radar chip, in accordance with the disclosed embodiments.

FIG. 11B presents the measurement results Vₒᵤₜ of the static displacement sensing at different object distance (d_{obj}) measured over a displacement range of corresponding to a Δϕ_{obj} range of 2π, and with a displacement step of 0.1, in accordance with the disclosed embodiments.

FIG. 11C presents measured static range resolution of the object's static displacement in accordance with the disclosed embodiments.

FIG. 12A shows the experiment setup for performing vibrational displacement (or “vibration”) sensing of a target object using a disclosed displacement-sensing radar chip, in accordance with the disclosed embodiments.

FIG. 12B shows the frequency spectra of analog output Yₒᵤₜ and corresponding range resolutions of measured vibrational displacement of the vibrating object in FIG. 12A at different vibrating frequencies and distances, in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The disclosed embodiments provide various displacement-sensing Doppler radar designs that simultaneously achieve ultra-low power consumption, ultra-low phase noise, freedom from detection nulls, and ultra-high displacement-sensing resolutions, without using quadrature demodulation. In some embodiments, the above properties of the disclosed displacement-sensing Doppler radars are achieved by a combination of the following design aspects of the disclosed Doppler radars. (1) Use of low-noise sub-sampling phase-locked loops (SSPLLs) with the same reference (REF) signal to generate single-tone transmitted/radiated signal and local oscillator (LO) signal without sidebands. As a result, no quadrature demodulation is needed. (2) Use of a rectifier to convert a down-converted IF sine-wave signal to a square-wave signal with sharp rising/falling edges. As a result, the displacement-induced phase information is converted into time domain regardless of the power/amplitude of the received signal from the target object. (3) A phase demodulator (PDM) that extracts the displacement-induced phase information from the down-converted and rectified IF square-wave signal by comparing the timings of the rising/falling edges of the REF signal (i.e., the demodulation signal) with the timings of the rising/falling edges of the IF square-wave signal. As a result, a pulse-wave signal is generated with pulse width and duty cycle of the pulse-wave signal proportional to input phase differences of the two signals detected by the PDM, and the phase information is converted to pulse duty cycle. (4) Coupling of a RC low-pass filter (LPF) to the PDM output to convert the pulse-wave signal into a voltage signal (V w) such that, if the target object is undergoing a static displacement, the DC level of Vₒᵤₜ will change proportionally with the displacement. However, if the target object is vibrating, Vₒᵤₜ will include a baseband signal having a frequency identical to the vibration frequency and having a voltage amplitude proportional to the target object's vibration displacement amplitude. (5) The two SSPLLs and the PDM use a common reference signal to generate the transmitted/radiated signal, the LO signal, and the demodulation IF signal. This signal coherence, combined with the low added noise ensured by the intrinsic features of SSPLL, significantly improves noise performance of the disclosed displacement-sensing radars and enables the disclosed radars to achieve the above-described optimal features.

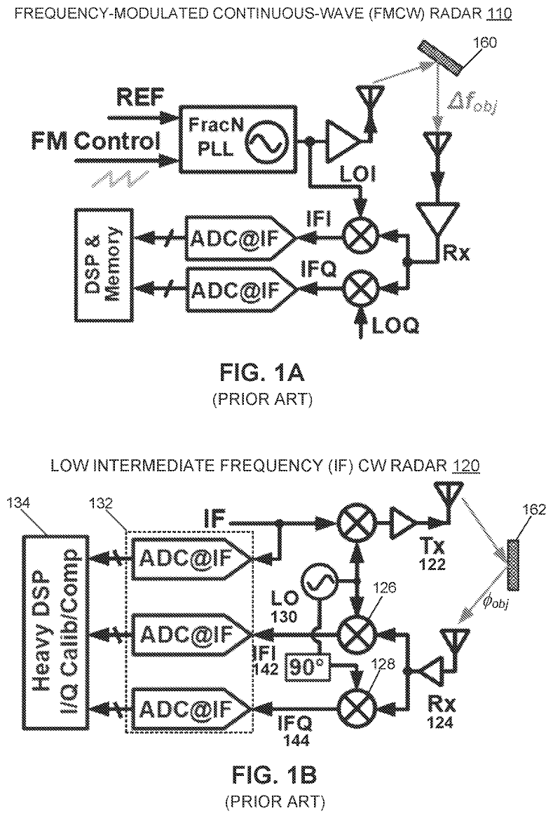

FIG. 1A shows an existing displacement-sensing frequency-modulated continuous-wave (FMCW) radar 110 using a phase demodulation technique for detecting both the absolute object distance (d_{obj}) and the object speed. In FMCW radar 110, the frequency of the transmitted signal toward a target object 160 is modulated in a predetermined pattern, which is typically linear-shaped (e.g., a sawtooth pattern) with a modulation bandwidth of ƒ_{BW}. As can be seen in FIG. 1A, the frequency of the received signal from target object 160 deviates from the transmitted frequency by αƒ_{obj}, which is proportional to the object distance d_{obj}. By mixing the received signal with the transmitted signal, Δƒ_{obj} can be extracted which is then used to calculate d_{obj}. The frequency demodulation technique used in FMCW radar 110 has a range resolution of d_{res;FMCW}=c/2ƒ_{BW}, wherein c is the speed of light in the propagation medium. It can be shown that, to achieve μm-level sensing resolutions in free space, ƒ_{BW} needs to be greater than 100 THz, which is unrealistic to implement with currently-available integrated circuit technologies. Hence, phase demodulation techniques, which require quadrature down-conversion to generate an intermediate frequency (IF) signal (shown in FIG. 1A as IFI and IFQ), are adopted in FMCW radars for high-accuracy applications.

However, due to the high frequency of the IF signal at or around Δƒ_{obj}, which can be theoretically up to the modulation bandwidth ƒ_{BW} of MHz or even GHz levels, high-speed and high-resolution analog-to-digital converters (ADCs) are needed to accurately convert the phase information in the IF signal into the digital domain. As a result, the total power consumption of FMCW radar 110 is significantly increased. Furthermore, due to non-idealities such as modulation pattern non-linearity and quadrature paths mismatch, additional calibrations and compensations have to be implemented in FMCW radar 110, which further increase the complexity and power consumption of the radar system.

FIG. 1B shows an existing displacement-sensing CW radar 120 based on a simpler low-IF topology for detecting object speed and relative displacement. Due to the use of the simpler low-IF topology, CW radar 120 generally consumes less power compared to FMCW radar 110. As can be seen in FIG. 1B, the transmitted signal (TX) 122, which is an unmodulated continuous wave, is radiated on a target object 162. The reflected signal (RX) 124 carrying object 162's displacement information is received by the receiver of CW radar 120, which includes a phase delay of:

$${ϕ}_{obj} = 4 π \cdot {d}_{obj} / {λ}_{c} , \qquad ( 1 )$$

wherein d_{obj} is object 162's distance to CW radar 120, and λ_{C} is the wavelength of the transmitted signal. However, CW radar 120 suffers from the intrinsic drawback of “detection nulls.” In other words, the detection gain of CW radar 120 periodically reaches “null” or zero when the object distance d_{obj} becomes an integer multiple of λ_{c}/4. This is because the phase-to-voltage gain of the radar receiver's down-conversion mixer is a non-linear sinusoidal function of the phase and the power of the received signal RX 124.

To avoid the detection nulls, CW radar 120 has to implement a quadrature demodulation scheme that uses two mixers 126 and 128 to mix the local-oscillator (LO) signal 130 with the received signal RX 124. By doing so, either the in-phase mixing path or the quadrature-phase mixing path will have a non-zero gain for any given d_{obj}. However, because both the in-phase mixing gain and the quadrature mixing gain (G_{MX,I} and G_{MX,Q}) are still non-linear functions of d_{obj}, both the in-phase IF signal (IFI) 142 and quadrature IF signal (IFQ) 144 from the two mixing paths are needed to construct the polar diagram for calculating ϕ_{obj} and d_{obj}. This is achieved by using multiple high-resolution ADCs 132 and an accurate digital signal processor (DSP) 134 on the two IF signals 142 and 144. Note that DSP 134 is needed to calibrate and compensate for the mismatch between the two demodulation/mixing paths that can cause both gain and phase errors. However, the requirements of multiple ADCs 132 and heavy DSP 134 significantly increase the power consumption of CW radar 120.

Note also that to mitigate both high “flicker” noise at baseband/low frequencies and a DC offset that can significantly decrease the detection accuracy of ϕ_{obj}, CW radar 120 further implements a low-IF topology, by utilizing a low IF signal frequency. However, this low IF frequency results in a double-sideband (DSB) transmitted signal TX 122 because neither of the two closely-located side-bands can be practically filtered out. This in turn results in a received DSB signal RX 124, which further necessitates the quadrature demodulation structure to be used to extract the phase information from the DSB signal RX 124. In addition to the intrinsic mismatch, the two mixers 126 and 128 in the two demodulation paths introduce two parts of independent noise, thereby further reducing detection accuracy.

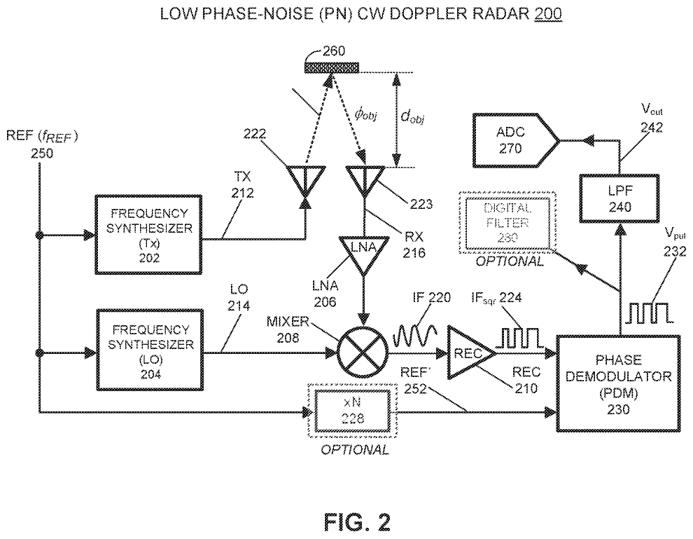

FIG. 2 shows a block diagram/topology of a disclosed low-noise CW Doppler radar 200 for object displacement and vibration sensing that eliminates detection nulls without using quadrature demodulation, in accordance with the disclosed embodiments.

As can be seen in FIG. 2, the disclosed low-noise CW Doppler radar 200 includes two frequency synthesizers 202 and 204. A common reference signal (REF) 250 with a frequency of ƒ_{REF}, is fed to the two frequency synthesizers 202 and 204 to generate a transmitted carrier (TX) signal 212 at a frequency ƒ_{TX} and the local-oscillator (LO) signal 214 at a frequency ƒ_{LO}, respectively. In some embodiments, ƒ_{REF} is an intermediate frequency, e.g., at 100 MHz or 1 GHz, and ƒ_{LO}=ƒ_{TX}+ƒ_{REF} such that Δƒ=ƒ_{LO}−ƒ_{TX}=ƒ_{REF}, which is also an intermediate frequency. Generally speaking, ƒ_{REF} should be significantly higher (e.g., >2×) than the highest motion/vibration frequency of the target object to be detected. In various embodiments, frequency synthesizers 202 and 204 are implemented with low phase-noise frequency synthesizers. For example, each of the frequency synthesizers 202 and 204 can be implemented with an integer-N sub-sampling phase-locked loop (SSPLL), which has ultra-low intrinsic in-band phase noise. As another example, each of the frequency synthesizers 202 and 204 can be implemented with an injection-locking frequency multiplier (ILFM), which also has extremely low phase noise. Note that using the low phase-noise frequency synthesizers such as SSPLLs to generate the TX 212 and LO 214 is one of the features of Doppler radar 200 that ensure ultra-low noise and ultra-high sensing resolutions.

TX signal 212 is radiated by a transmitter antenna 222 toward a target object 260 where object displacements and/or vibrations are to be detected, and the radiated power is reflected off target object 260 and back toward Doppler radar 200. A receiver antenna 223 is used to receive the reflected signal/power from target object 260 and generate a received (RX) signal 216 carrying an object-induced phase delay of ϕ_{obj} (also referred to as the “detected phase information” or “phase information” below) corresponding to the object distance of d_{obj}, wherein the relationship between ϕ_{obj} and d_{obj} was described by Eqn. (1). Note that both transmitter antenna 222 and receiver antenna 223 can be integrated with and therefore be a part of the disclosed Doppler radar 200. However, in other embodiments, either or both transmitter antenna 222 and receiver antenna 223 can be implemented as separate components/structures and used in tandem with the disclosed Doppler radar 200 but not being a part of the disclosed Doppler radar 200.

When object 260 is moving/vibrating, its distance d_{obj}(t) to Doppler radar 200 and the induced phase delay ϕ_{obj}(t) are both functions of time. In some embodiments, receiver antenna 223 includes a balun that is configured to produce a differential RX signal 216 according to:

$${V}_{RX} ( t ) = {A}_{RX} sin [ 2 π {f}_{c} t - {ϕ}_{obj} ( t ) ] , \qquad ( 2 )$$

wherein A_{RX}, which a function of d_{obj}, is the amplitude of RX signal 216. Note that because TX signal 212 generated by frequency synthesizer 202 is a single-tone signal without sidebands, the received RX signal 216 is also a single-tone signal without sidebands. As a result, extracting the phase information ϕ_{obj} from RX signal 216 does not require any quadrature demodulation, which allows the disclosed Doppler radar 200 to further reduce phase noise and power consumption compared with the above-described FMCW and CW Doppler radars 110 and 120.

As can be seen in FIG. 2, Doppler radar 200 further includes a low-noise amplifier (LNA) 206 and a mixer 208 in the path of the received signal. Specifically, RX signal 216 produced by receiver antenna 223 is first amplified by LNA 206, and then down-converted by mixer 208 using LD signal 214 generated by frequency synthesizer 204. Note that LNA 206 is used to provide additional signal gain for the received signal 216. In various embodiments, LNA 206 is a differential LNA, and mixer 208 is configured with both differential input and differential output. Moreover, LNA 206 can be implemented to have any number of amplification stages (e.g., 1 stage, 2 stages, 3 stages, etc.). In some embodiments, instead of using receiver antenna 223 to convert a single-ended input signal reflected off object 260 into the differential RX signal 216, LNA 206 can be configured to first convert the single-ended input signal into a two-ended differential signal (e.g., using a balun), and then amplify the differential signal with a diff amp. In some embodiments, LNA 206 may be made into an optional component of Doppler radar 200 by configuring the LNA gain to 1.

After low-pass filtering by mixer 208, the differential output from mixer 208 is an IF signal 220 (or “IF 220”) carrying the phase information ϕ_{obj}. In some embodiments, IF signal 220 has the same frequency ƒ_{REF} as REF 250. This is achieved by configuring the two frequency synthesizers 202 and 204 to generate TX signal 214 and LO signal 214 at frequencies ƒ_{TX} and ƒ_{LO}, respectively, such that ƒ_{REF}=ƒ_{LO}−ƒ_{TX}. For example, in an implemented Doppler radar further described below, ƒ_{REF}=1 GHz, ƒ_{TX}=39 GHz; ƒ_{LO}=40 GHz, and therefore ƒ_{IF}=ƒ_{REF}=1 GHz.

Generally speaking, the frequency ƒ_{IF} of IF signal 220 can be any value based on the following relationship with ƒ_{REF}:

$${f}_{IF} = \vert {f}_{LO} - {f}_{TX} \vert = \vert {N}_{2} - {N}_{1} \vert {f}_{REF} = N \cdot {f}_{REF} , \qquad ( 3 )$$

wherein ƒ_{TX}=N₁×ƒ_{REF},ƒ_{LO}=N₂×ƒ_{REF}, N is an integer number, and N₁ and N₂ can be both integer numbers and fractional numbers. For example, in the example above, N₁=40 and N₂=39. However, in another example based on Eqn. (3), N₁=39 and N₂=40, which are both integer numbers. In yet another example based on Eqn. (3), N₁=40.5 and N₂=39.5, which are both fractional numbers. In all three numerical examples, ƒ_{IF}=ƒ_{REF}=1 GHz and N=1. In yet another example, N₁=40 and N₂=36 so that N=4, and ƒ_{IF}=4×ƒ_{REF}=4 GHz. To handle the above flexibility in the designs of Doppler radar 200, a “×N” frequency multiplier 228 can be inserted between REF 250 and one of the two inputs to phase demodulator (PDM) 230 (described below) to convert REF 250 into REF 252 with a frequency ƒ_{REF}′=N×ƒ_{REF}, which is the same exact frequency as ƒ_{IF}=N×ƒ_{REF}. Note that “×N” frequency multiplier 228 becomes optional when N=1. This is indicated by a shaded box that encloses “×N” frequency multiplier 228 in FIG. 2.

Further referring to Doppler radar 200 of FIG. 2, note that a rectifier (REC) 210 is positioned after mixer 208 to receive IF signal 220 and subsequently convert IF signal 220 from a sine-wave signal into a square-wave (IF_{sqr}) signal 224. Note that this conversion operation by rectifier 210 synchronizes the rising/falling edges of IF_{sqr} signal 224 with the rising/falling zero-crossings of IF signal 220. As a result, the phase information ϕ_{obj}(t) originally carried by RX signal 216 is now embedded in the temporal locations of the rising/falling edges of IF_{sqr} signal 224. The rectified square-wave IF_{sqr} signal 224 as a function of time t can be expressed as:

$${V}_{IFsqr} ( t ) = \frac{1}{2} + \frac{1}{2} sgn \{ sin [ 2 π {f}_{REF} t + {ϕ}_{obj} ( t ) ] \} , \qquad ( 4 )$$

wherein “sgn” is the sign function.

Note that the signal conversion operation of rectifier 210 is not sensitive to the changes in amplitude of the sine-wave IF signal 220. As a result, the temporal locations of the rising/falling edges of the converted square-wave IF_{sqr} signal 224, which carries the phase information ϕ_{obj}(t), will not change as a result of changing amplitude A_{RX} of IF signal 220. This property of rectifier 210 allows for further reduction of the phase sensing errors. However, it is still desirable to have sufficiently high RX signal 216 power and sufficiently high receiver gain to produce sharp rising and falling edges in IFsgr signal 224. Moreover, the temporal locations of the rising/falling edges of IFsgr signal 224 are not sensitive to the specific gain of LNA 206 or mixer 208. Consequently, the signal propagation path including LNA 206, mixer 208, and rectifier 210 provides a constant cascaded phase-to-phase gain of G_{RX}=1 for ϕ_{obj}(t). In some embodiments, the order of LNA 206 and mixer 208 shown in FIG. 2 can be reversed, such that RX signal 216 is first mixed with LO signal 214 before being amplified by LNA 206. Note that, in these embodiments, LNA 206 and rectifier 210 can be combined into a single component.

It may be noted that Doppler radar 200 further includes a phase demodulator (PDM) 230 positioned downstream from rectifier 210 to receive both IF_{sqr} signal 224 and converted reference signal REF 252 as inputs, wherein IF_{sqr} signal 224 and REF 252 have the same frequency. In specific embodiments, IF_{sqr} signal 224 and REF 252 have the same frequency as REF 250 at ƒ_{REF}, wherein REF 252 and REF 250 are identical to each other. Because the two square-wave signals input to PDM 230 have the same frequency, and the phase information is embedded in the square-wave edges of IF_{sqr} signal 224, PDM 230 is configured to compare the rising or the falling edges of IF_{sqr} signal 224 with the corresponding rising or falling edges of REF 252 to extract ϕ_{obj}(t) from the square-wave edges of IF_{sqr} signal 224. Note that by using PDM 230 to extract the phase information ϕ_{obj} directly from IF_{sqr} signal 224 converted from single-tone RX signal 216, no quadrature demodulation is needed.

Without losing generality, we consider the embodiment of REF 250=REF 252 and ƒ_{REF}=ƒ′_{REF}. A person skilled in the art can readily appreciate that the equivalent input to PDM 230 is the phase difference Δϕ(t) between IF_{sqr} signal 224 and REF′ 250, wherein Δϕ(t)=ϕ_{obj}(t)−ϕ_{REF}(t) and ϕ_{REF}(t) is the default static phase of REF 250. As will be described in more detail below, the output of PDM 230 is a pulse-wave signal Vₚᵤₗ(t) 232 at the same frequency ƒ_{REF}, but with a duty cycle Dₚᵤₗ(t) proportional to Δϕ(t), i.e., Dₚᵤₗ(t)=Δϕ(t)/(2π). As such, Vₚᵤₗ(t) 232 is also referred to as the pulse-width-modulated signal Vₚᵤₗ(t) 232. Thus, in the phase domain, PDM 230 produces a constant phase-to-duty-cycle gain of G_{PDM}(ƒ)=∂Dₚᵤₗ(ƒ)/∂Δϕ(ƒ)=1/(2π). Moreover, the amplitude of Vₚᵤₗ(t) 232 equals the supply voltage V_{FS} of PDM 230.

As can be seen in FIG. 2, Doppler radar 200 further includes an analog low-pass filter (LPF) 240 positioned further downstream from PDM 230 in the signal processing path of Doppler radar 200. Analog LPF 240 receives pulse-width-modulated signal Vₚᵤₗ(t) 232, which is filtered by LPF 240 to convert the pulses into an output voltage signal Vₒᵤₜ(t) 242. In the frequency domain, Vₒᵤₜ(t) 242 can be expressed as:

$${V}_{out} ( f ) = {V}_{FS} {H}_{LPF} ( f ) {D}_{pul} ( f ) = {V}_{FS} Δ ϕ ( f ) {D}_{pul} ( f ) , \qquad ( 5 )$$

wherein V_{FS} is the full supply voltage and H_{LPF}(ƒ) is the transfer function of LPF 240. Note that Vₒᵤₜ(t) can be either a DC signal or baseband (i.e., low-frequency) signal depending on whether the detected object 260 is static (thereby generating a constant ϕ_{obj}) or vibrating (thereby generating an oscillating ϕ_{obj}(t)).

Note that in addition to converting pulse-width-modulated signal Vₚᵤₗ(t) into either a DC or baseband signal Vₒᵤₜ(t), analog LPF 240 can also help remove (through the intrinsic low-pass filtering property) those high frequency noises in Vₚᵤₗ(t), i.e., at frequencies significantly higher than the baseband frequencies. For example, any high frequency noise associated with the frequency synthesizers 202 and 204 can be effectively eliminated by LPF 240, making the detection output Vₒᵤₜ immune to high frequency noises. Thus, in the phase domain, LPF 240, together with the PMD 230's supply voltage V_{FS}, provides a duty-cycle-to-voltage gain of G_{LPF}(ƒ)=∂Vₒᵤₜ(ƒ)/∂Dₚᵤₗ(ƒ)=V_{FS}H_{LPF}(ƒ). Note that for certain applications when the target object 260 is a live subject or when the detected motion has a low rate of change, the extracted frequencies of baseband signal Vₒᵤₜ(t) are also very low (e.g., in the few Hz range).

After generating the detection output signal Vₒᵤₜ(t), an ADC 270 converts output signal Vₒᵤₜ(t) into a digital signal for further processing. Note that, compared with FMCW or conventional Doppler radars 110 and 120 that required two or more ADCs sampling at high IF frequencies, Doppler radar 200 of FIG. 2 requires at most one ADC at the output operating at DC or low baseband frequencies, thereby making the Doppler radar significantly less power-consuming than FMCW and conventional Doppler radars. Note that ADC 270 can be integrated with Doppler radar 200 as a part of Doppler radar 200, or ADC 270 can be implemented as a separate component operating in tandem with Doppler radar 200.

In some embodiments, instead of using analog LPF 240 before ADC 270, a digital filter 280 can be used to replace both analog LPF 240 and ADC 270 to perform low-pass digital filtering of Vₚᵤₗ(t) from the high carrier frequency (e.g., at 1 GHz) to either DC or the low baseband frequency. In FIG. 2, digital filter 280 is enclosed within a shaded box to indicate that using digital filter 280 is an optional and alternative solution to using LPF 240 and ADC 270 to process Vₚᵤₗ(t).

The displacement detection gain of Doppler radar 200, Ga, can be calculated based on Eqn. (1), G_{RX}, G_{PDM} and G_{LPF} as:

$${G}_{det} ( f ) = \frac{\partial {V}_{out}}{\partial {d}_{obj}} = \frac{\partial {ϕ}_{obj}}{\partial {d}_{obj}} {G}_{RX} {G}_{PDM} {G}_{LPF} = \frac{2 {V}_{FS} {H}_{LPF} ( f )}{{λ}_{c}} , \qquad ( 6 )$$

Eqn. (6) shows that, because rectifier 210's phase-to-phase gain, PDM 230's phase-to-pulse-width gain, and LPF 240's pulse-width-to-voltage gain are all constant values, the disclosed Doppler radar 200 also has a substantially constant detection gain and therefore is free of detection nulls. Furthermore, when the power of RX signal 216 and/or the receiver gain from LNA 206 are sufficiently high to produce sharp-edge IF_{sqr} signal 224, Doppler radar 200 demodulates ϕ_{obj}(t) into Vₒᵤₜ(t) with a constant gain regardless of the received signal power from target object 260. Consequently, additional power detection and calibration are not needed, thereby further reducing total power consumption of Doppler radar 200.

Doppler radar 200 achieves the overall ultra-low noise operation as a result of a combination of several design features. First, Doppler radar 200 uses the SSPLL, which has ultra-low intrinsic in-band phase noise, or the equivalent ultra-low phase noise frequency synthesizers to generate the TX and LO signals. Second, only one channel of signal mixing path with a single mixer is used to extract the phase information ϕ_{obj} from the RX signal without using any quadrature demodulation, thereby allowing Doppler radar 200 to further reduce phase noise (and power consumption) compared with existing FMCW and CW Doppler radars that have two channels of mixer noises due to using quadrature demodulation. Third, analog LPF 240 at the output of Doppler radar 200 can help eliminate (through the intrinsic low-pass filtering property) any added flicker (low-frequency) noise or any high frequency noise (e.g., from the VCOs in the SSPLLs) at frequencies significantly higher than the baseband frequencies of the target subject 260.

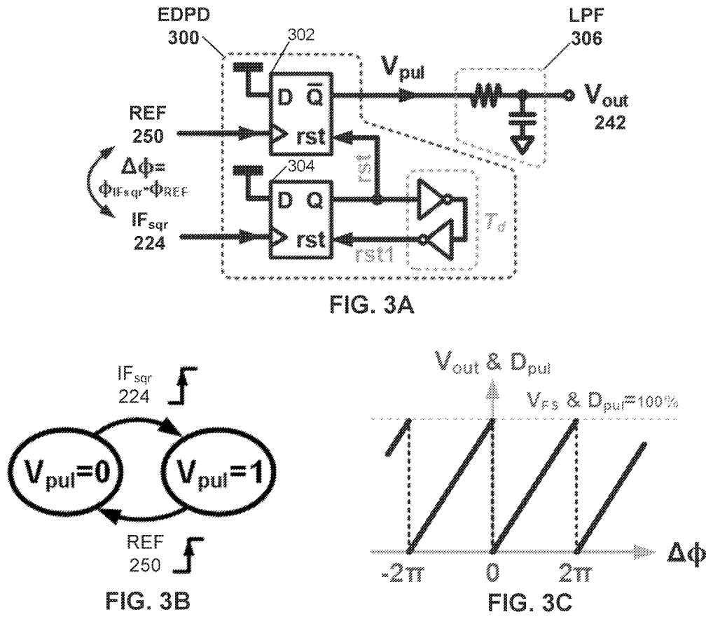

Fourth, just one portion of the phase noise of REF 250 is transferred into TX signal 212 and RX signal 216, and after mixing and rectifying operations, is carried by IF_{sqr}, signal 224. However, PDM 230 is configured to compare IF_{sqr} signal 224 with REF 250 or REF′ 252, which both include the same phase noise (i.e., the common mode noise) of REF 250. As a result, the phase noise of REF 250 is cancelled by the differential comparison operation of PDM 230, thereby further reducing the overall phase noise of Doppler radar 200. Fifth, as further described below in conjunction with FIG. 3A-3C, PDM 230 has intrinsic low phase-noise when using the all-digital architecture of EDPD 300, which is significantly lower than the phase noise of the mixer. The same Doppler radar 200 also eliminates detection nulls because the rectifier's phase-to-phase gain, the PDM's phase-to-pulse-width gain, and the LPF's pulse-width-to-voltage gain are all constant values.

### Implementation of PDM 230: Edge-Driven Phase Demodulator (EDPD)

FIG. 3A shows a circuit diagram of an edge-driven phase demodulator (EDPD) 300 as an implementation of PDM 230 in Doppler radar 200 for extracting the object-induced phase and frequency changes from the edges of IF_{sqr} signal 224, in accordance with the disclosed embodiments. As can be seen in FIG. 3A, the two input signals of EDPD 300 are IF_{sqr} signal 224 and REF 250 (assuming N=1 in block 228 in FIG. 2), wherein EDPD 300 includes two D flip-flops 302 and 304. Each of the input signals is coupled into the clock input of a respective flip-flop 302 or 304. Also shown in FIG. 3A is an off-chip LPF 306 coupled to the output of EDPD 300, and used to generate the displacement detection output Vₒᵤₜ 242 of Doppler radar 200. However, LPF 306 is not a part of EDPD 300.

As described above, both IF_{sqr} signal 224 and REF 250 are square waves whose rising-edge or falling-edge zero-crossing times represent the phases of the respective signals. Moreover, the phase difference between a pair of corresponding rising-edges or falling-edges of the two signals (i.e., Δϕ_{obj}(t)=ϕIF_{sqr}−ϕ_{REF}) includes the phase delay induced by either static displacement or vibrational displacement (or simply “vibrations”) of target object 260. The pair of flip-flops 302 and 304 compares pairs of rising edges or pairs of falling edges between IF_{sqr} signal 224 and REF 250 and subsequently generates a pulse wave signal Vₚᵤₗ(t) with a modulated pulse duty cycle proportional to the timing/phase differences of the pairs of edges. While not common, it is also possible to configure EDPD 300 to compare a rising edge in one of IF_{sqr} signal 224 and REF 250 with a falling edge in the other one of IF_{sqr} signal 224 and REF 250 to generate the pulse wave signal Vₚᵤₗ(t).

Because IF_{sqr} signal 224 is a varying modulated signal containing ϕ_{obj}(t), EDPD 300 is configured as a state machine that utilizes REF 250 to clock IF_{sqr} signal 224. FIG. 3B shows the state machine operating principle of EDPD 300 for comparing the rising/falling edges of IF_{sqr} signal 224 and REF 250 in accordance with the disclosed embodiments. Assuming a rising-edge comparison scheme is implemented, generally speaking, EDPD 300 is configured to wait for the arrivals of rising edges of IF_{sqr} signal 224 and REF 250 and then compare them into a pulse having a duty cycle proportional to the detected time difference of the two rising edges. Specifically, when a rising edge of REF 250 is detected, the output Vₚᵤₗ of EDPD 300 immediately transitions to ZERO (0); whereas when a rising edge of IF_{sqr} signal 224 is detected, the output Vₚᵤₗ of EDPD 300 immediately transitions to ONE (1). In this manner, the width/duty cycle of the current pulse in Vₚᵤₗ(t) is proportional to the phase/time delay, i.e., the arrival of the next rising edge of REF 250.

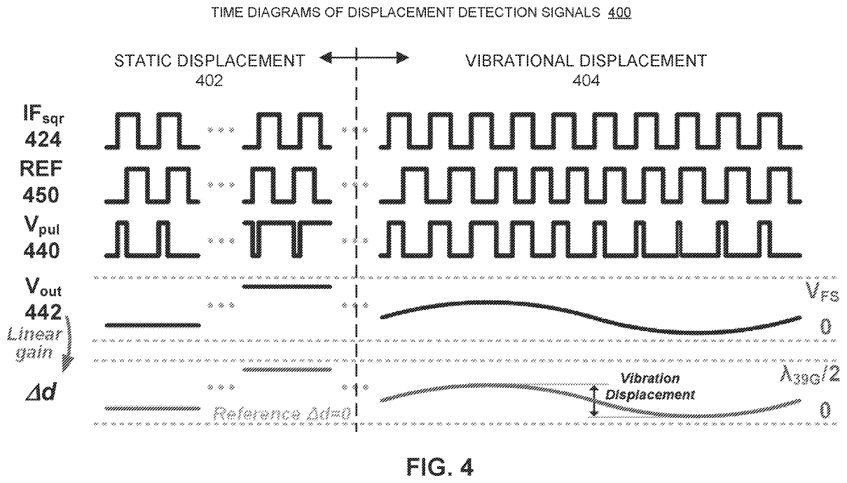

In the above-described pulse generation scheme, the two rising edges being compared in IF_{sqr} signal 224 and REF 250 should have a relatively large time difference such that they occur at sufficiently different times for the state machine to respond. When the times of arrival of the two rising edges are too close to each other, the width/duty cycle of the generated pulse becomes very narrow, causing either a very high Vₒᵤₜ or a very low Vₒᵤₜ (demonstrated in the third row Vₚᵤₗ 440 in the timing diagrams of FIG. 4). To mitigate such scenarios, a level detector can be added to sense and take advantage of the very high and very low Vₒᵤₜ levels. If either a very high or a very low Vₒᵤₜ level is detected, the level detector can generate a positive detection output, which can be used to invert REF 250 (i.e., with a 180° phase shift). This phase inversion operation will then cause much wider pulses to be generated instead. As an alternative solution, a second and parallel EDPD can be added that is configured to detect and compare falling edges of IF_{sqr} signal 224 and REF 250 (assuming the original EDPD 300 is configured to detect and compare falling edges). During two-EDPD operation, only one of the two EDPDs will be selected and active depending on the detection outputs of the level detector, and the two EDPDs can be switched back and forth as the active EDPD based on the outputs of the level detector.

FIG. 3C shows the constant-gain operation principle of EDPD 300 when converting the detected phase differences between IF_{sqr} signal 224 and REF 250 into the duty cycles of Vₚᵤₗ(t) and the DC levels of Vₒᵤₜ(t), in accordance with the disclosed embodiments. As can be seen in FIG. 3C, λϕ_{obj}(t) (i.e., the equivalent input to EDPD 300) is converted linearly to the duty cycle Dₚᵤₗ(t) of EDPD 300 output Vₚᵤₗ(t), with a constant gain of G_{EDPD}(s)=1/(2π). Because Vₒᵤₜ(t) at the output of the LPF 240 is proportional to Dₚᵤₗ(t), the plot of FIG. 3C equally represents the relationship of λϕ_{obj}(t) versus Vₚᵤₗ(t). Due to the above-described operating principle of the state machine, both Dₚᵤₗ(t) and Vₚᵤₗ(t) are monotonic signals with respect to Δϕ_{obj}(t). As a result, the disclosed Doppler radar 200 can distinguish the displacement directions (i.e., either away from or toward the radar) of the target object 260, indicated by the sign/direction of change (i.e., either increase or decrease) of Vₒᵤₜ, without ambiguity.

FIG. 4 illustrates exemplary timing diagrams 400 of different signals involved in the operations of PDM 230/EDPD 300 associated with different detection cases of the target object, in accordance with the disclosed embodiments. Specifically, the left side of time diagrams 400 is associated with the case when the target object is under a static displacement 402. Under such a detection case, when an exemplary IF_{sqr} signal 424 leads an exemplary reference (REF) 450 by a phase difference less than π, an exemplary output of the displacement detection Vₒᵤₜ 442, is a DC value close to 0. In contrast, when IF_{sqr} signal 424 lags REF 450 by a phase difference less than π, Vₒᵤₜ 442 is a DC value close to its full-scale value of V_{FS}, which is the supply voltage of EDPD 300. Separately, the right side of time diagrams 400 is associated with the case when the target object is under a vibrational displacement 404. Under such a detection case, because the vibrating object induces a time-varying displacement Δd and phase delay Δϕ, the demodulated Vₚᵤₗ(t) 440 is associated with a time-varying but periodic duty cycle Dₚᵤₗ(t). As a result, the displacement detection output Vₒᵤₜ is also a time-varying and periodic signal that represents both the displacement and vibration frequency information.

### Detailed Implementations of the Disclosed Doppler Radar

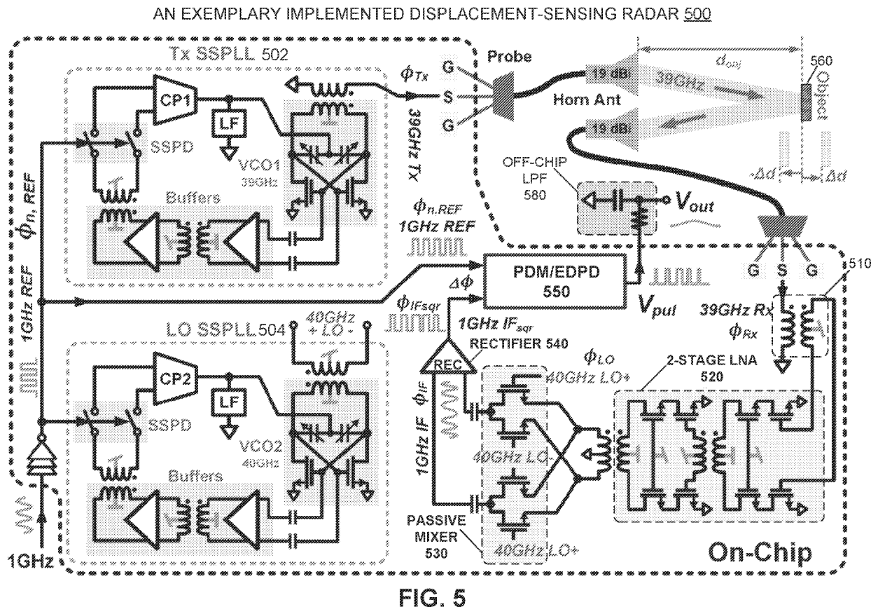

FIG. 5 illustrates a circuit diagram/radar 500 of a detailed implementation of the proposed Doppler radar 200 in accordance with the disclosed embodiments. As can be seen in FIG. 5, an off-chip reference REF signal at ƒ_{REF}=1 GHz having a phase noise (PN) of ϕ_{n,REF} is fed into radar 500. A TX signal at frequency ƒ_{c}=39 GHz and a LO signal at frequency ƒ_{LO}=40 GHz are generated by a first low-PN SSPLL 502 and a second low-PN SSPLL 504, respectively, and having the associated output phases ϕ_{TX} and ϕ_{LO}, respectively. Two external horn antennae with 19 dBi gain are used to radiate the TX signal and receive the reflected signal from a target object 560 under detection. Specifically, the TX signal is passed to a G-S-G pad of the transmitter horn antenna from the VCO tank of the first SSPLL 502. Note that target object 560 has a distance d_{obj} away from the horn antennae and a relative displacement of Δd. As a result, an object-induced phase delay of ϕ_{obj}=4π(d_{obj}+Δd)/λ_{39G} is added to ϕ_{TX}, wherein λ_{39G} is the wavelength of the TX signal, which results in the phase of the received signal at the receiver antenna. The single-ended received signal is then converted to a differential RX signal with phase ϕ_{RX}=ϕ_{TX}+ϕ_{obj} by an on-chip balun 510, which is then fed to a 2-stage LNA 520.

To minimize the added low-frequency noise around the baseband frequencies (which is also referred to as the “flicker noise”) from the mixer, a passive double-balanced mixer 530 is used to down-convert the RX signal to an IF signal at ƒ_{IF}=1 GHz and an output phase of ϕ_{IF}. Because SSPLLs 502 and 504 are both referenced to the same REF signal, their upscaled PNs are correlated. Consequently, just one portion (×1) of ϕ_{n,REF} from REF 250 is propagated into the IF signal's phase ϕ_{IF}. Neglecting added noise from rectifier 540, the rectified signal IF_{sqr} 224 has a phase ϕF_{sqr} equal to ϕ_{IF}, including phase noise ϕ_{n,REF}. Next, EDPD 550 compares IF_{sqr} signal 224 with the same REF signal, wherein both signals include the same common mode noise of the REF signal. As a result, the phase noise of the REF signal is cancelled by the differential comparison operation of EDPD 550, thereby further reducing the overall phase noise of Doppler radar 500. An off-chip LPF 580 composed of a tunable resistor and a 10 nF capacitor is used to convert Vₚᵤₗ to a voltage of Vₒᵤₜ=V_{FS}×Dₚᵤₗ, where V_{FS} is the full-scale value of Vₒᵤₜ and the supply voltage to PDM/EDPD 550. Note that an object displacement of Δd shown in FIG. 5 produces a voltage change of ΔVₒᵤₜ, with a constant detection gain of ΔVₒᵤₜ/Δd=2V_{FS}/λ₃₉.

We now describe some of the functional modules within circuit diagram/radar 500 in detail. Note that some detailed implementations of PDM/EDPD 550 in radar 500 have already been described above.

### Sub-Sampling Phase-Locked Loops (SSPLLs)

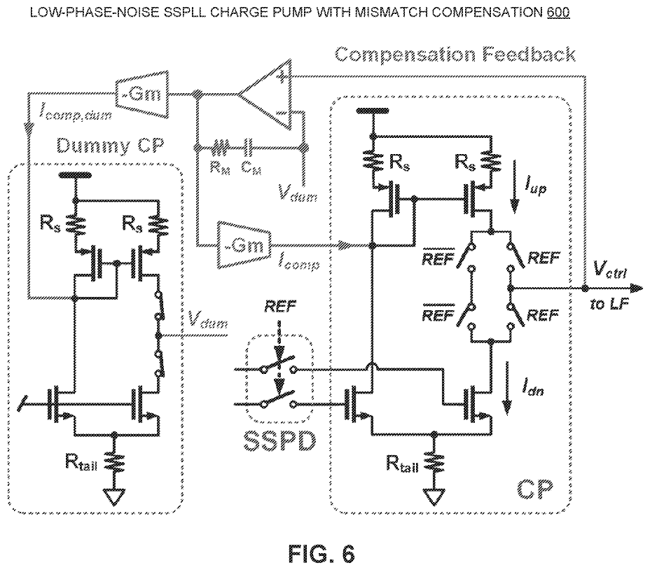

As an inherent property of a SSPLL, the noises from the phase-detector (SSPD) and the charge pump in the SSPLL do not upscale by N² (wherein N is the ratio of a given PLL's output to input frequencies) to the output as in traditional divider-based PLLs, making the SSPLL a suitable frequency synthesis topology with low uncorrelated added noise for the disclosed displacement-sensing radar. To further reduce the in-band noise of a SSPLL, the transistor-based current mirror inside the CP can be replaced with a tail resistor in the CP's current biasing to further reduce the flicker noise. FIG. 6 shows the circuit diagram of a charge pump 600 of the low-PN SSPLLs used in the implemented radar 500 in accordance with the disclosed embodiments.

As can be seen in FIG. 6, a tail resistor Rₜₐᵢₗ replaces the transistor-based current mirror in the CP 600's current biasing. Moreover, current mirroring devices are source-degenerated through resistors Rₛ to minimize the added flicker noise by these current mirroring devices. Also shown in CP 600, a current mismatch compensation technique based on using a dummy CP and the compensation feedback is applied to expand the locked VCO control-voltage range for robust operation. This mismatch compensated CP has been described in international patent application PCT/US2021/055065, entitled “Current-Mismatch Compensated Charge Pump for Phase-Locked Loop Applications” and filed on Oct. 14, 2021, the contents of which are incorporated by reference as a part of this patent document. In radar 500, the two SSPLLs 502 and 504 are identically designed. As a result, both SSPLLs 502 and 504 have the same loop transfer functions. The VCO-contributed noise in each of the SSPLLs 502 and 504 is high-pass filtered by the corresponding SSPLL, and is further low-pass filtered by the LPF 550 at the output of radar 500. These additional noise management features allow the design requirements of the VCO noise to be relaxed.

### LNA and Mixer

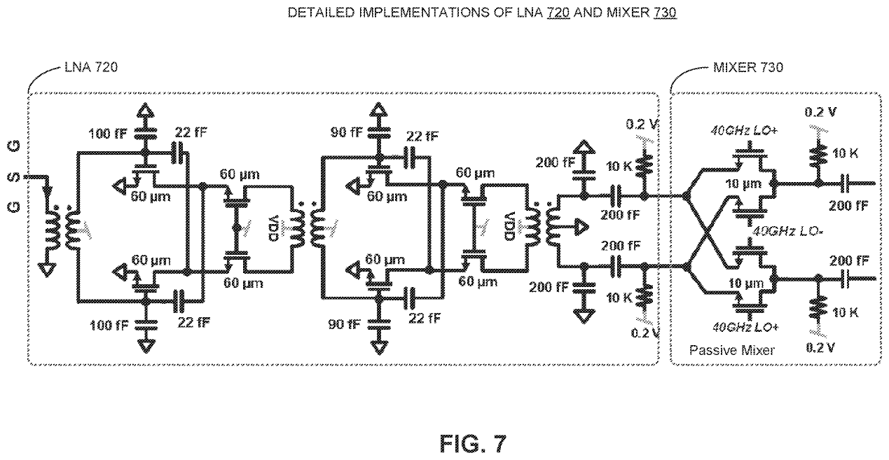

FIG. 7 shows circuit diagrams of LNA 720 and passive mixer 730 as detailed implementations of LNA 520 and passive mixer 530 implemented in radar 500, in accordance with the disclosed embodiments. As can be seen in FIG. 7, the proposed LNA 520/720 includes two stages of differential cascode amplifiers. As mentioned above, the input signal to the receiver of radar 500 is converted to a differential signal by balun 510 and then fed to the inputs of the first stage of 2-stage LNA 520/720. Note that balun 510 also helps match the input impedance of LNA 520. Neutralization capacitors are used in LNA 520/720 to enhance stability and gain of the LNA. The transformer between the first and the second stage of LNA 720 significantly simplifies the circuit layout and can also function as the inter-stage matching network.

A fully differential double-balanced passive mixer circuit 730 is shown on the right side of FIG. 7. Theoretically, because there is no DC current passing through the mixer, there is no flicker noise generated by the switching transistors. However, because of the finite rise time and fall time of the LO signals, some flicker noise exists at the output of mixer 730. Nevertheless, the DC bias of the LO signal can be tuned near the threshold voltage of the mixer transistors to achieve better switching behavior and further reduce flicker noise.

### IF Rectifier

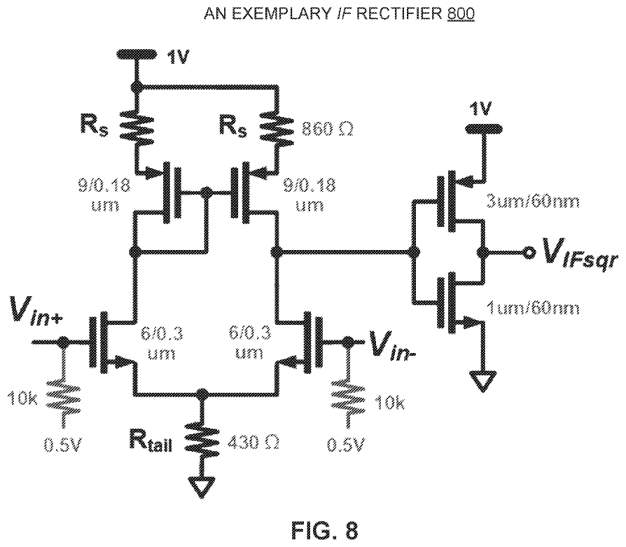

FIG. 8 shows a circuit diagram of an IF rectifier 800 as a detailed implementation of rectifier 540 implemented in radar 500, in accordance with the disclosed embodiments. As can be seen in FIG. 8, IF rectifier 800 is configured to first convert the differential sine-wave input IF signal, which is the output of mixer 530 into a single-ended signal, and subsequently rectify the single-ended signal into the square-wave signal IF_{sqr}. Generally speaking, IF rectifier 800 should have a sufficiently high gain to produce sharp edges in IF_{sqr} in order to trigger the PDM 230/EDPD 300. In the implementation of IF rectifier 800, the differential-to-single-ended amplifier stage provides a voltage gain of 5.4 (14.6 dB) at 1 GHz. With the same design consideration of minimizing added flicker/low-frequency noise as in CP 600, resistor biasing with Rₜₐᵢₗ and source-degeneration resistors R_{S} are again used in the first amplifier stage to reduce the added flicker noise. An inverter in IF rectifier 800 serves as the second stage to rectify the output of IF rectifier 800. In other embodiments of rectifier 540, more gain stages beyond the two stages shown can be readily added to further increase the detection sensitivity and the detection range of the implemented radar 500.

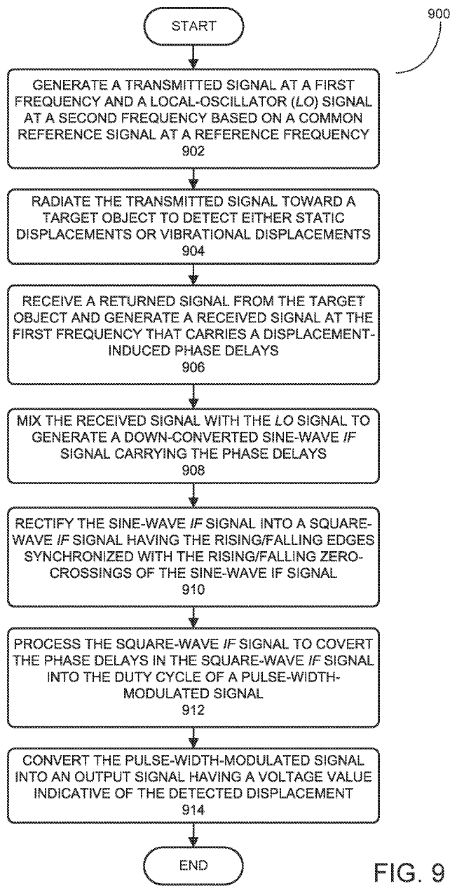

FIG. 9 presents a flowchart illustrating a process 900 performed by the disclosed displacement-sensing radar for detecting both static displacements and vibrational displacements of a target object in accordance with the disclosed embodiments. During operation, process 900 begins with generation of a transmitted (TX) signal at a first frequency (ƒ₁) and a local-oscillator (LO) signal at a second frequency (ƒ₂) different from the first frequency, wherein both the first and the second frequencies are generated based on a common reference signal at a third frequency of ƒ_{REP} (step 902). In some embodiments, the difference between the first and the second frequencies is the third frequency (i.e., |ƒ₁−ƒ₂|=ƒ_{REF}). The transmitted signal is then radiated through a transmitter antenna toward a target object where either static displacements or vibrational displacements of the target object are to be detected (step 904). A return signal reflected off the target object is then received using a receiver antenna, which generates a received (RX) signal at frequency ƒ₁ that carries displacement-induced phase delays corresponding to a type of detected displacement of the target object (step 906). Note that the types of displacement of the target object that can be sensed by the disclosed displacement-sensing radar include both a static displacement and a vibrational displacement.

Next, process 900 includes mixing the received signal with the LO signal using a mixer to generate a down-converted sine-wave IF signal, wherein the down-converted sine-wave IF signal carries the displacement-induced phase delays (step 908). Next, the down-converted sine-wave IF signal is rectified into a square-wave IF signal, wherein the rising/falling edges of the square-wave IF signal are synchronized with the rising/falling zero-crossings of the down-converted sine-wave IF signal (step 910). As a result, the displacement-induced phase delays originally carried by the received (RX) signal are embedded in the temporal locations/timings of the rising/falling edges of the square-wave IF signal. The down-converted and rectified square-wave IF signal also has the third frequency—the frequency (ƒ_{REF}) of the common reference signal.

Next, the square-wave IF signal is processed to convert the displacement-induced phase delays embedded in the square-wave IF signal into the duty cycle of a pulse-width-modulated signal (step 912). Note that the duty cycle of the pulse-width-modulated signal is a functional of time, and has a value proportional to the displacement-induced phase delays. In some embodiments, the square-wave IF signal is converted into the pulse-width-modulated signal by using an edge-driven phase demodulator (EDPD) described above in conjunction with FIGS. 3A-3C, and 4-5, which is configured to compare the rising or the falling edges of the square-wave IF signal with the corresponding rising or falling edges of the common reference signal, and generate the pulse-width-modulated signal having a duty cycle proportional to the displacement-induced phase delays.

Subsequently, the pulse-width-modulated signal is converted into an output signal having a voltage value indicative of the detected displacement (step 914). Specifically, when the detected displacement of the target object is a static displacement, the output voltage signal is a DC signal having a level indicative of the static displacement. In contrast, when the detected displacement of the target object is a vibrational displacement, the output voltage signal is a time-varying baseband signal that has a frequency identical to the vibration frequency and an amplitude proportional to the amplitude of the vibrational displacement.

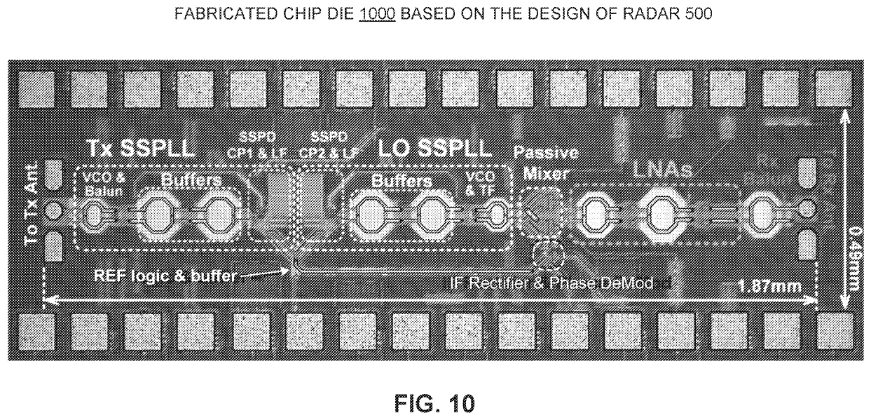

FIG. 10 shows a photograph of a fabricated chip die 1000 of the disclosed displacement-sensing radar 500 in 65 nm CMOS with a core area of 0.92 mm² in accordance with the disclosed embodiments. The total power consumption of the radar chip 1000 was measured to be 110 mW, with 32.6 mW for the TX SSPLL (16 mW for the VCO, 15.6 mW for the RF buffers, 1 mW for the CP), 25.8 mW for the LO SSPLL (12 mW for the VCO, 12.7 mW for the RF buffers, 1 mW for the CP), 46.2 mW for the LNA, 0.4 mW for the IF Rectifier and the EDPD, and 4.7 mW for REF buffer and logic circuits. The measured TX signal (at 39 GHz) power at the TX output pad was 2.8 dBm, and the EIRP at transmitter antenna was measured to be 15.5 dBm. A Keithley 5.5-digit digital multimeter (DMM) mimicking an ADC is connected to the Vₒᵤₜ of the chip die 1000.

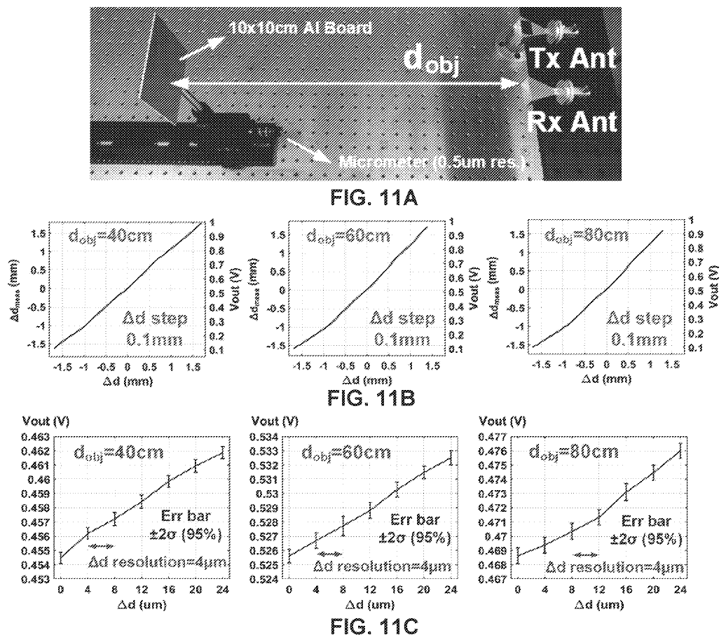

FIG. 1A shows the experiment setup for performing static displacement sensing of a target object using the disclosed and fabricated displacement-sensing radar chip 1000, in accordance with the disclosed embodiments. As can be seen in FIG. 11A, a 10×10 cm² aluminum board with micrometer-adjusted positioning is used as an object. FIG. 11B presents the measurement results Vₒᵤₜ of the static displacement sensing at different object distance (d_{obj}) measured over a displacement range corresponding to a Δϕ_{obj} range of 2π, and with a displacement step of 0.1 mm in accordance with the disclosed embodiments. As can be seen in FIG. 11B, the displacement range corresponding to the Δϕ_{obj} range of 2π is approximately λ_{39G}/2=3.8 mm. Note that the measurement results shown in FIG. 11B verify that detection nulls have been eliminated using the disclosed Doppler radar design, because the detection gain G_{det}=∂Vₒᵤₜ(ƒ)/∂_{obj} never reaches zero. FIG. 11C presents measured static range resolution of the object's static displacement in accordance with the disclosed embodiments. As can be seen in FIG. 11C, a range resolution of d_{δ,static}=4 μm for various static-displacement measurements was observed.

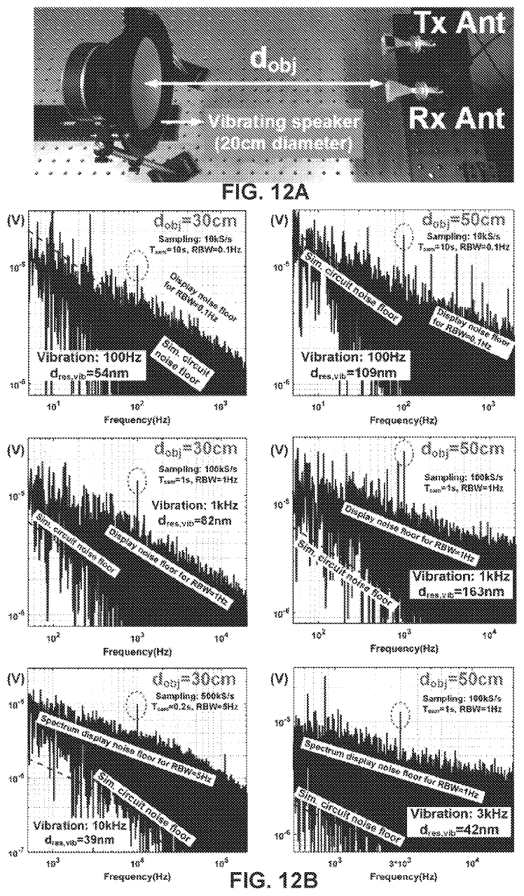

FIG. 12A shows the experiment setup for performing vibrational displacement (or “vibration”) sensing of a target object using the disclosed and fabricated displacement-sensing radar chip 1000, in accordance with the disclosed embodiments. As can be seen in FIG. 12A, a loudspeaker with a 20 cm-diameter diaphragm, made of aluminum-magnesium alloy, acts as the target object. The loudspeaker is driven by a signal source to control the vibration frequency and amplitude of the target object. The radar's analog output Vₒᵤₜ is sampled by the DMM, with sampling rates labelled in FIG. 12B below. Fast Fourier transform is applied on the sampled Vₒᵤₜ to obtain the frequency spectra, indicating vibration frequencies and amplitudes.

FIG. 12B shows the frequency spectra of analog output Vₒᵤₜ, and corresponding range resolutions of measured vibrational displacement of the vibrating object in FIG. 12A at different vibrating frequencies and distances, in accordance with the disclosed embodiments. Note that in various vibration sensing measurements shown in FIG. 12B, different total sampling times, Tₛₐₘ, were used, which resulted in different resolution bandwidths (RBW)=1/Tₛₐₘ and different power spectrum densities as shown. For each vibration measurement, the actual loudspeaker's vibrating amplitudes were calibrated with a Keyence LK-H057 laser vibrometer, which has an accuracy (i.e., repeatability) of 25 nm and highest sampling rate of 392 kHz. It should be noted that the laser vibrometer calibrates the vibration amplitude only at a 50 μm×2 mm spot on the speaker's diaphragm that has the maximum vibration, while the radar has an aperture covering the whole diaphragm with uneven vibration amplitudes at different locations. Hence, the measured vibration amplitudes in voltage in FIG. 12B are the aggregations of all the vibrating points on the diaphragm.

Note that laser-calibrated vibration amplitudes were provided in FIG. 12B as measured vibrational-displacement-sensing resolution, d_{δ,vib}. All of the measured d_{δ,vib} are at least ×2 of the total local noise floor. Due to lower flicker noise impact and lower noise floor, the measured vibrational-displacement-sensing resolutions were as low as tens of nanometers as shown in FIG. 18B. More specifically, the measured vibration-sensing resolutions for different object's vibrating frequencies are: d_{δ,vib}(100 Hz)=109 nm, d_{δ,vib}(kHz)=163 nm, and d_{δ,vib}(3 kHz)=42 nm for d_{δ,vib}=50 cm, and d_{δ,vib}(10 kHz)=39 nm for d_{obj}=30 cm. These measured vibration-sensing resolutions are lower than calculated theoretical vibration-sensing resolutions of d_{δ,vib}(100 Hz)=30 nm, d_{δ,vib}(1 kHz)=9 nm, and d_{δ,vib}(10 kHz)=3 nm, due to the added noise by the DMM and the higher noise floor associated with the RBW and the Tₛₐₘ used in each measurement.

The embodiments of a displacement-sensing Doppler radar disclosed herein can be used in a wide range of applications for detecting/sensing both static and vibrational displacements of target objects with high to ultra-high resolutions. These intended applications, and hence the aforementioned target object 260 in FIG. 2 and target object 560 in FIG. 5, can include but are not limited to: (1) biomedical applications (e.g., for detecting/sensing human vital signs such as heart beat rate, respiration rate, seizure detection during sleep); (2) agricultural applications (e.g., leaf thickness and water content measuring for precision-irrigation and water-conservation); (3) architectural applications, including vibration sensing for safety monitoring of bridges, walls, steel-structured buildings; and (4) manufacturing applications including measuring material flatness (e.g., the flatness of steel boards or films) and vibration sensing (e.g., measuring vehicle body's vibration/isolation from the vehicle engine).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein. The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A displacement-sensing Doppler radar, comprising:
a first frequency synthesizer configured to generate a transmitted signal of a first frequency (ƒ₁), which is radiated toward a target object;
a second frequency synthesizer configured to generate a local oscillator (LO) signal of a second frequency (ƒ₂) different from the first frequency;
a mixer configured to:
receive a returned signal from the target object carrying displacement-induced phase delays corresponding to detected displacements of the target object; and
mix the returned signal and the LO signal to generate a down-converted intermediate frequency (IF) signal, wherein the down-converted IF signal carries the displacement-induced phase delays;
a phase demodulation module configured to convert the displacement-induced phase delays into a modulated pulse signal; and
a low-pass filter (LPF) configured to convert the modulated pulse signal into an output signal having a voltage value indicative of the detected displacements.

2. The displacement-sensing Doppler radar of claim 1, wherein the first frequency synthesizer and the second frequency synthesizer use a common reference (REF) signal of a reference frequency (ƒ_{REF}) to generate the transmitted signal and the LO signal so that the transmitted signal and the LO signal have correlated phase noises according to the phase noise of the common REF signal.

3. The displacement-sensing Doppler radar of claim 2, wherein:
the transmitted signal has the first frequency ƒ₁=N₁×ƒ_{REF};
the returned signal has the same frequency as the transmitted signal;
the LO signal has the second frequency ƒ₂=N₂×ƒ_{REF}; and
the down-converted IF signal has an intermediate frequency ƒ_{IF}=|ƒ₁−ƒ₂|=N₁−N₂|×ƒ_{REF}=N×ƒ_{REF}, wherein N is an integer number.

4. The displacement-sensing Doppler radar of claim 3, wherein N=1 such that the down-converted IF signal has the same frequency as the common REF signal.

5. The displacement-sensing Doppler radar of claim 2, further comprising a rectifier positioned between the mixer and the phase demodulation module and configured to rectify the down-converted IF signal from a sine-wave signal into a square-wave IF signal, wherein rising/falling edges of the square-wave IF signal are synchronized with the rising/falling zero-crossings of the sine-wave signal.

6. The displacement-sensing Doppler radar of claim 5, wherein the rectifier has a constant phase-to-phase conversion gain when converting the rising/falling zero-crossings of the sine-wave signal into the rising/falling edges of the square-wave IF signal.

7. The displacement-sensing Doppler radar of claim 5, wherein the displacement-induced phase delays are embedded in the temporal locations of the rising/falling edges of the square-wave IF signal.

8. The displacement-sensing Doppler radar of claim 7, wherein the phase demodulation module is configured to convert the displacement-induced phase delays into the modulated pulse signal by:
receiving both the square-wave IF signal and the common REF signal;
comparing the rising/falling edges of the square-wave IF signal with the corresponding rising/falling edges of the common REF signal to detect phase differences between the rising/falling edges of the square-wave IF signal and the rising/falling edges of the common REF signal, wherein the detected phase differences are proportional to the displacement-induced phase delays; and
generating the modulated pulse signal based on the detected phase differences, wherein the duty cycle of the modulated pulse signal is time-varying with a value which is linearly proportional to the detected phase differences.

9. The displacement-sensing Doppler radar of claim 8, wherein the square-wave IF signal and the common REF signal have the same frequency.

10. The displacement-sensing Doppler radar of claim 8, wherein the phase demodulation module is an edge-driven phase demodulator that further comprises:
a first flip-flop to receive the square-wave IF signal; and
a second flip-flop to receive the common REF signal;
wherein the first flip-flop and the second flip-flop are coupled into a state machine which is configuration such that:
when a rising/falling edge of the common REF signal is detected, the signal level of the modulated pulse signal is immediately transitioned to ZERO (0); and
when a rising/falling edge of the square-wave IF signal is detected, the signal level of the modulated pulse signal is immediately transitioned to ONE (1).

11. The displacement-sensing Doppler radar of claim 8, wherein the phase demodulation module has a constant phase-to-pulse width conversion gain for different detected phase differences.

12. The displacement-sensing Doppler radar of claim 8, wherein the low pass filter is configured to convert the modulated pulse signal into the output voltage signal having an amplitude linearly proportional to the duty cycle of the modulated pulse signal, which itself is linearly proportional to the detected phase differences, wherein the output voltage signal includes a baseband signal associated with displacements of the target object.

13. The displacement-sensing Doppler radar of claim 12, wherein the low pass filter has a constant duty-cycle-to-voltage conversion gain for different generated duty cycles in the modulated pulse signal.

14. The displacement-sensing Doppler radar of claim 12, wherein the low pass filter is configured to filter out phase noises in the modulated pulse signal at frequencies significantly higher than the frequencies of the baseband signal.

15. The displacement-sensing Doppler radar of claim 14, wherein the frequencies of the baseband signal include a vibration frequency associated with a vibration displacement of the target object.

16. The displacement-sensing Doppler radar of claim 1, wherein both the first frequency synthesizer and the second frequency synthesizer are low phase noise synthesizers.

17. The displacement-sensing Doppler radar of claim 16, wherein:
the first frequency synthesizer is a first low-noise frequency synthesizer selected from the following:
a first sub-sampling phase-locked loop (SSPLL); and
a first frequency multiplier, and
the second frequency synthesizer is a second low-noise frequency synthesizer selected from the following:
a second SSPLL; and
a second frequency multiplier.

18. The displacement-sensing Doppler radar of claim 5, wherein the Doppler radar is configured to avoid detection nulls by:
using the rectifier to perform a constant-gain phase-to-phase conversion from the sine-wave IF signal into the square-wave IF signal;
using the phase demodulation module to perform a constant-gain phase-to-pulse width/duty cycle conversion from the square-wave IF signal into the modulated pulse signal; and
using the low pass filter to perform a constant-gain duty-cycle-to-voltage-level conversion from the modulated pulse signal to the output voltage signal.

19. The displacement-sensing Doppler radar of claim 1, wherein both the transmitted signal and the returned signal are single-tone signals without sidebands, which allows the displacement-induced phase delays to be extracted from the returned signal using a single mixer without using a quadrature demodulation configured of two mixers or a quadrature demodulation on the square-wave IF signal in digital signal processing to extract the displacement-induced phase delays.

20. The displacement-sensing Doppler radar of claim 1, further comprising:
a receiver antenna configured to receive the returned signal; and
a low noise amplifier (LNA) configured to receive the returned signal and amplify the returned signal to provide additional signal gain.

21. The displacement-sensing Doppler radar of claim 1, further comprising an analog-to-digital converter (ADC) disposed after the LNA and configured to convert the output voltage signal into a digital signal for further processing.

22. The displacement-sensing Doppler radar of claim 1, further comprising no more than one ADC to convert the output voltage signal.

23. The displacement-sensing Doppler radar of claim 1, wherein:
when the target object is undergoing a static displacement, the output voltage signal is a direct current (DC) signal having a level indicative of the static displacement; and
when the target object is undergoing a vibrational displacement, the output voltage signal is a baseband signal having a frequency identical to the vibration frequency and having a voltage amplitude proportional to an amplitude of the vibrational displacement.

24. The displacement-sensing Doppler radar of claim 1, wherein the output signal can be used to distinguish the displacement directions of the target object based on the direction of change of the voltage value.

25. A method for detecting object displacements using a Doppler radar, the method comprising:
generating a transmitted signal of a first frequency;
radiating the transmitted signal toward a target object to cause the transmitted signal to be reflected off the target object;
receiving a returned signal reflected off the target object carrying displacement-induced phase delays corresponding to a type of detected displacement of the target object;
mixing the received signal with a local oscillator (LO) signal to generate a down-converted intermediate frequency (IF) signal, wherein the down-converted IF signal carries the displacement-induced phase delays;
processing the down-converted IF signal so that the displacement-induced phase delays is converted into a modulated pulse signal; and
converting the modulated pulse signal into an output signal having a voltage value indicative of the detected displacement.

26. The method of claim 25, wherein prior to mixing the received signal with the LO signal, the method further comprises generating the LO signal at a second frequency different from the first frequency, wherein both the first frequency and the second frequency are generated based on a common reference signal at a third frequency of ƒ_{REF}.

27. The method of claim 25, wherein the difference between the first frequency and the second frequency is ƒ_{REF}.

28. The method of claim 25, where the type of detected displacement of the target object includes a static displacement and/or a vibrational displacement.

29. The method of claim 25, wherein the down-converted IF signal is a sine-wave IF signal, and wherein processing the down-converted IF signal to convert the displacement-induced phase delays into the modulated pulse signal further includes:
rectifying the sine-wave IF signal into a square-wave IF signal so that the rising/falling edges of the square-wave IF signal are synchronized with the rising/falling zero-crossings of the sine-wave IF signal,
wherein the displacement-induced phase delays are embedded in the rising/falling edges of the square-wave IF signal.

30. The method of claim 29, wherein the square-wave IF signal has the same frequency as the third frequency of ƒ_{REF}, and wherein processing the down-converted IF signal to convert the displacement-induced phase delays into the modulated pulse signal further includes:
comparing the rising edges or the falling edges of the square-wave IF signal with the corresponding rising edges or falling edges of the common reference signal; and
generating the modulated pulse signal having a duty cycle proportional to the displacement-induced phase delays.

31. The method of claim 29, wherein the output voltage signal has an amplitude linearly proportional to the duty cycle of the modulated pulse signal.

32. The method of claim 25, wherein prior to mixing the received signal, the method further comprises amplifying the received signal to provide additional signal gain.

33. The method of claim 25, wherein after converting the modulated pulse signal into the output voltage signal, the method further comprises converting the output voltage signal into a digital signal for further processing.

34. The method of claim 25, wherein the type of detected displacement is a static displacement, and wherein the output voltage signal is a direct current (DC) signal having a level indicative of the static displacement.

35. The method of claim 25, wherein the type of detected displacement is a vibration displacement comprising a vibration frequency, and wherein the output voltage signal is a baseband signal having a frequency identical to the vibration frequency and having a voltage amplitude proportional to an amplitude of the vibrational displacement.

36. The method of claim 35, wherein the detected vibrational displacement has a detection accuracy significantly less than 100 nm.

37. The method of claim 25, wherein the transmitted signal is a single-tone signal without sidebands, and wherein the received signal and the LO signal are mixed to generate the down-converted IF signal with a single mixer without using either a quadrature demodulation configured with two mixers or a quadrature demodulation configured with a digital signal processor (DSP) to extract the displacement-induced phase delays.

38. A displacement-sensing apparatus, comprising:
a transmitting antenna;
a receiver antenna; and
a continuous wave (CW) Doppler radar coupled to the transmitting antenna and the receiver antenna, wherein the CW Doppler radar further comprises:
a first frequency synthesizer configured to generate a transmitted signal of a first frequency, which is radiated by the transmitting antenna toward a target object;
a low noise amplifier (LNA) configured to amplify a received signal outputted by the receiver antenna, wherein the received signal is generated based on a returned signal reflected off the target object, and wherein the returned signal carrying displacement-induced phase delays corresponding to detected displacements of the target object;
a mixer configured to mix the received signal and a local oscillator (LO) signal to generate a down-converted sine-wave intermediate frequency (IF) signal, wherein the down-converted sine-wave IF signal carries the displacement-induced phase delays;
a rectifier configured to convert the sine-wave IF signal into a square-wave IF signal, wherein the displacement-induced phase delays are embedded in the rising/falling edges of the square-wave IF signal;
a phase demodulation module configured to convert the displacement-induced phase delays into a modulated pulse signal; and
a low-pass filter (LPF) configured to convert the modulated pulse signal into an output signal having a voltage value indicative of the detected displacements.

39. The displacement-sensing apparatus of claim 38, further comprising a second frequency synthesizer configured to generate the LO signal of a second frequency different from the first frequency, and wherein both the first frequency and the second frequency are generated based on a common reference signal at a third frequency of ƒ_{REF}.

40. The displacement-sensing apparatus of claim 38, wherein the target object has a distance d_{obj} to both the transmitting antenna and the receiver antenna, and wherein the displacement-induced phase delays include a phase delay ϕ_{obj}=4π·d_{obj}/λ_{c}, wherein λ_{c} is the wavelength of the transmitted signal.
